(19) United States
(12) Patent Application Publication
(10) Pub. No.: US 2007/0216649 A1
(43) Pub. Date: Sep. 20, 2007

(54) Method and device for optical input, and a spectroscopic lens module of the device

(76) Inventor: Huanbiao LANG, GUANGDONG PROVINCE (CN)

Correspondence Address: Eric Chan, 42 Pin Oaks Drive, Phoenixville, PA, 19460, US

(21) Appl. No.: 11/457,838

(22) Filed: Jul. 17, 2006

(30) Foreign Application Priority Data
Apr. 5, 2006 (CN) 200610067153.3
Mar. 17, 2006 (CN) 200620056368.0

(51) Int. Cl. G09G 5/08

(52) U.S. Cl. 345/166; 345/156

(57) ABSTRACT

The optical input device of the present invention comprises a casing, an optical sensor component, a light source and a spectroscopic lens module. The optical sensor component, the light source and the spectroscopic lens module are disposed inside the casing. The spectroscopic lens module comprises a prism, a spectroscope and a lens. The prism is disposed on one side of the light source where light rays are emitted. The spectroscope is disposed on one side of the prism where light rays are emitted. The lens is disposed on one side of the spectroscope where light rays are emitted. The lens module comprising the prism, the lens and the spectroscope allows more images on the medium surface to be captured and enables the optical input device to operate smoothly on glossy surfaces (glass, marble, metal, transparent plastic or photo paper) and multi-colored surfaces.

### BACKGROUND OF THE INVENTION

The present invention relates to an optical input device.

The lens module of a convention optical mouse in the prior art can only capture images on colored rough surfaces. It cannot capture images on certain medium surfaces such as glossy surfaces (glass, marble, metal, transparent plastic or photo paper) and multi-colored surfaces. Therefore, wired and wireless optical mice and other optical input devices cannot be used on certain medium surfaces such as glossy surfaces (glass, marble, metal, transparent plastic or photo paper) and multi-colored surfaces. This brings about much inconvenience to users.

As illustrated in FIG. 1, the optical system of a conventional optical input device comprises an infrared light source 2, a prism 32, a lens 34 and an optical sensor component 1. Light rays from the infrared light source 2 are refracted by the prism 32 to strike the medium surface at an angle of 22.50 degrees relative to the surface and a transmission point P1 is created. If there is a discrepancy A on the distance between the lens 34 and the medium surface, the transmission point P1 will deviate from the centre of the lens. The deviation between the transmission point P1 and the centre of the lens is illustrated as B. In this case, the optical sensor component will have a lower capability of capturing information on the medium surface.

### BRIEF SUMMARY OF THE INVENTION

It is an object of the present invention to provide an optical input device, an optical input method and a spectroscopic lens module of the optical input device which can be used on glossy and multi-colored surfaces.

To attain this, the optical input device of the present invention generally comprises a casing, an optical sensor component, an infrared light source and a spectroscopic lens module. The optical sensor component, the infrared light source and the spectroscopic lens module are disposed inside the casing. The spectroscopic lens module comprises a prism which refracts incident rays such that the angle between the refracted light rays and the medium surface is 1.00 degree, a spectroscope which refracts incident rays such that the angle between the refracted light rays and the medium surface is 89.00 degrees, and a high-precision bi-focus aspheric toric lens. The prism is disposed on one side of light source where light rays are emitted. The spectroscope is disposed on one side of the prism where light rays are emitted. The lens is disposed on one side of the spectroscope where light rays are emitted.

The spectroscopic lens module further comprises a base. The base, the prism, the spectroscope and the lens are assembled together as a whole.

The prism, the lens and the spectroscope are embedded in corresponding receptacles of the base respectively.

The angle between the spectroscope and the medium surface is 44 degrees. The angle between the prism and the medium surface is 44.5 degrees.

The spectroscopic lens module of the optical input device comprises a prism, a spectroscope and a lens. The prism is disposed on one side of the infrared light source where light rays are emitted. The spectroscope is disposed on one side of the prism where light rays are emitted. The lens is disposed on one side of the spectroscope where light rays are emitted.

The optical input method comprises the following steps:

1) Light rays are emitted from an infrared light source;

2) Light rays from the infrared light source are refracted by a prism to a refractive surface of a spectroscope such that the angle between the refracted light rays and the medium surface is 1.00 degree;

3) Light rays refracted to the refractive surface of a spectroscope are refracted by the spectroscope such that the angle between the light rays refracted from the spectroscope and the medium surface is 89.00 degrees;

4) Light axis of the refracted light rays having an angle of 89.00 degrees relative to the medium surface which are refracted from the spectroscope is directed to reach the medium surface, and light axis of images on the medium surface is reflected to the spectroscope;

5) Light rays of the images from the medium surface are transmitted to the bi-focus aspheric toric lens by the spectroscope. The optical sensor component then captures images processed by the bi-focus aspheric toric lens.

The said step 4 further comprises the following: Light axis of the refracted light rays is simultaneously directed to an image surface, the height of which is different from that of the medium surface. Light axis of images on the image surface is then reflected to the spectroscope. The said step 5 further comprises the following: Light rays of the images from the image surface are simultaneously transmitted to the bi-focus aspheric toric lens.

In comparison with the prior art, the advantage of the present invention is the provision of a lens module which comprises a prism, a bi-focus aspheric toric lens and a spectroscope. It allows more images on the medium surface to be captured and enables the optical input device to operate smoothly on glossy and multi-colored surfaces.

### BRIEF DESCRIPTION OF THE DRAWINGS

FIG. 1 is a schematic diagram showing the light paths of a conventional optical input device.

FIG. 2 is a cross-sectional view of the optical input device of the present invention.

FIG. 3 is a partially enlarged view of the area marked “P” in FIG. 2.

FIG. 4 is a schematic diagram showing the light paths of the present invention.

FIG. 5 is a disassembling view of the spectroscopic lens module of the present invention before assembling.

FIG. 6 is a perspective view of the spectroscopic lens module of the present invention.

FIG. 7 is another perspective view of the spectroscopic lens module of the present invention as viewed from another perspective.

FIG. 8 is the front view of the spectroscopic lens module of the present invention.

FIG. 9 is the cross-sectional view taken along line A-A in FIG. 8.

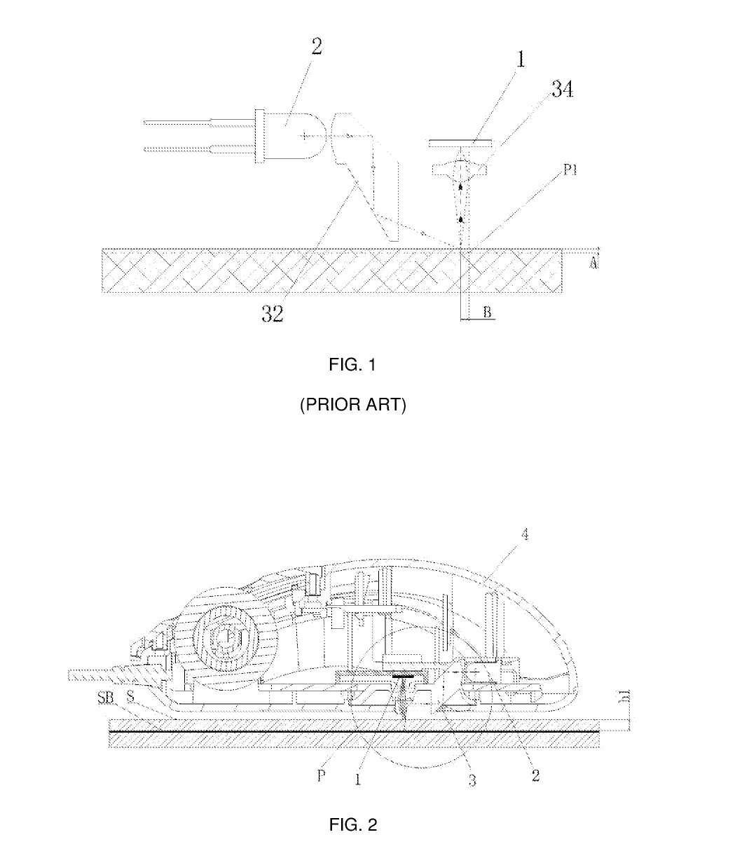

### DETAILED DESCRIPTION OF THE INVENTION

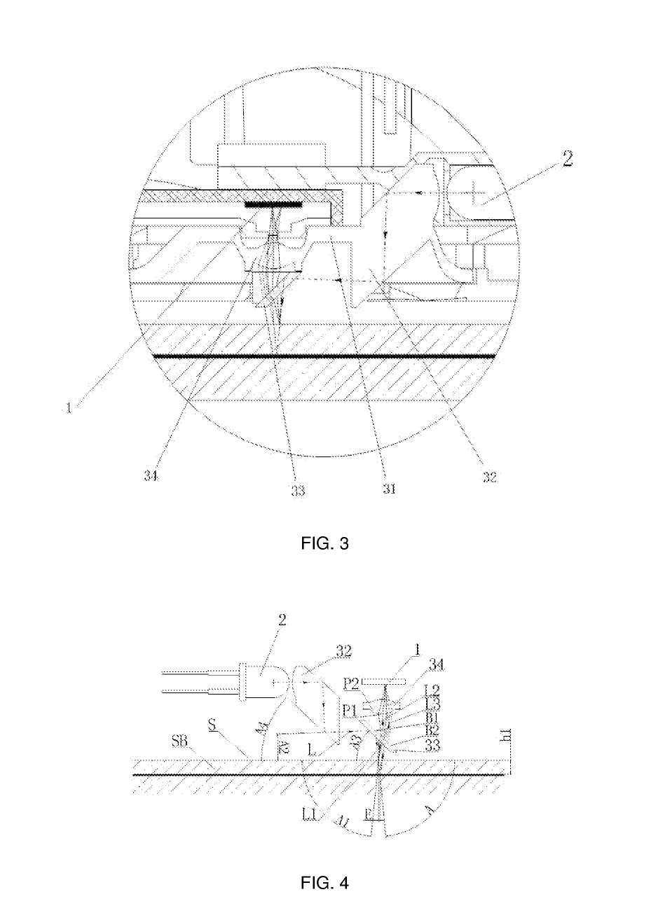

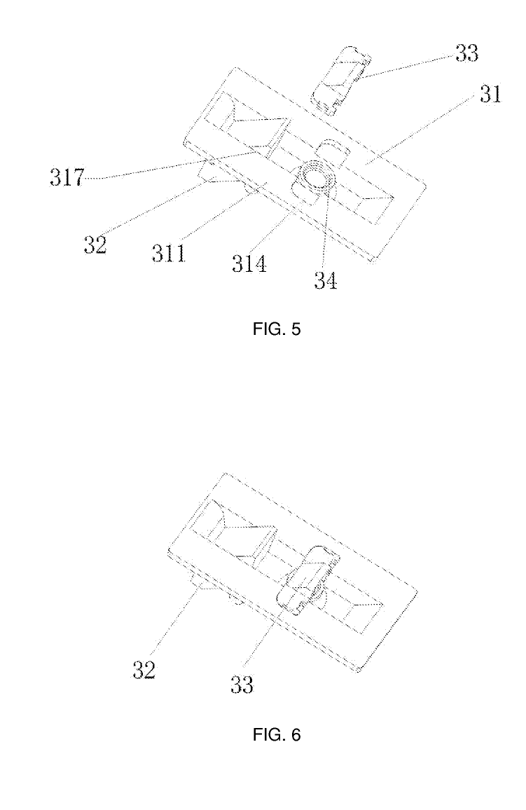

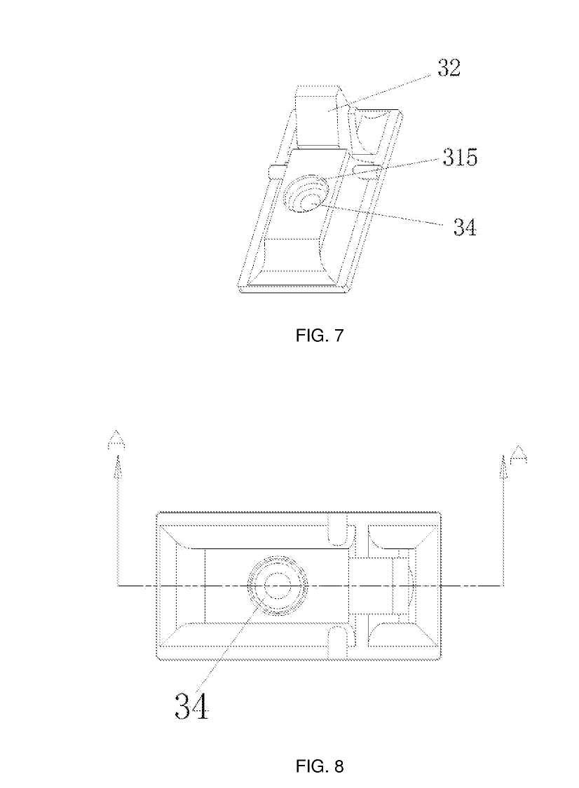

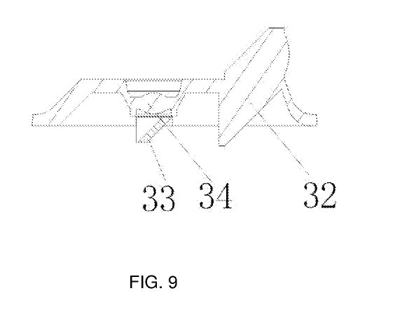

As illustrated in FIG. 2 to FIG. 9, the present invention relates to an optical input device such as an optical mouse. It comprises a casing 4, an optical sensor component 1, an infrared light source 2 and a spectroscopic lens module 3. The optical sensor component 1, the infrared light source 2 and the spectroscopic lens module 3 are disposed inside the casing 4. The optical sensor component 1 and the infrared light source 2 are mounted on a circuit board which is disposed above the spectroscopic lens module 3. The light source 2 may take the form of a conventional infrared LED. The spectroscopic lens module 3 comprises a base 31, a prism 32, a spectroscope 33 and a lens 34. The prism 32 is embedded in the corresponding receptacle 317 of the base 31 and is disposed on one side of the light source 2 where light rays are emitted. The spectroscope 33 is embedded in the corresponding receptacle 314 of the base and is disposed on one side of the prism 32 where light rays are emitted. The lens 34 is embedded in the corresponding receptacle 315 of the base and is disposed on one side of the spectroscope 33 where light rays are emitted. The four components are assembled together as a whole to form the spectroscopic lens module 3. The module can also be integrally formed as a whole by injection molding. In this embodiment, the prism 32 is disposed on one side of the light source 2 where light rays are emitted, the spectroscope 33 is disposed on one side of the prism 32 where light rays are emitted, the lens 34 is disposed on one side of the spectroscope 33 where light rays are emitted, and the optical sensor component 1 is disposed on one side of the lens 34 where light rays are emitted. The lens 34 is a high-precision bi-focus aspheric toric lens which enables the optical sensor component 1 to capture more optical images on a medium surface, thus enhances the capability of the spectroscopic lens module in capturing optical images on certain medium surfaces such as glossy surfaces (glass, marble, metal, transparent plastic or photo paper) and multi-colored surfaces. The mechanical and electrical structures of the optical input device are the same as those in the prior art and so no detailed description is provided herein.

The optical input device operates as follows: the spectroscopic lens module 3 enables the optical sensor component to capture two-way images simultaneously:

1. Light rays emitted from the light source 2 are refracted by the prism 32 such that the angle A2 between refracted light rays L and the medium surface S is 1.00 degree. The light rays L is directed to the refractive surface B2 of the spectroscope 33 such that the angle A between the light rays L1 refracted from the spectroscope 33 and the medium surface S is 89.00 degrees. Light axis of the refracted light rays having an angle of 89.00 degrees relative to the medium surface is directed to reach the medium surface S. The medium surface S may take the form of glossy surface (glass, marble, metal, transparent plastic or photo paper), multi-colored surface and so forth. Images on the medium surface S are then reflected to the spectroscope 33 (the angle A1 between the light rays of the images and the medium surface S is 89.00 degrees). After that, light rays L2 of the images are transmitted to the bi-focus aspheric toric lens 34 by the spectroscope 33 (light axis L2 is processed by aspheric toric surface P1). The optical sensor component 1 of wired or wireless optical mice or other optical input devices then captures images processed by the lens 34, thus enhances the capability of the optical sensor component 1 in capturing images on various medium surfaces.

2. To enable the optical sensor component 1 of wired or wireless optical mice or other input devices to better capture images on image surfaces SB at different heights (h1 being the error range caused by refraction characteristics of the medium surface) simultaneously, a bi-focus aspheric toric lens is used for capturing images of another light axis L3. Light rays from the LED light source are refracted by the prism 32 such that the angle between the refracted light rays L and the medium surface S is 1.00 degree. The light rays L are directed to the spectroscope 33 such that the angle between the refracted light rays L1 and the medium surface S is 89.00 degrees. The light rays L1 are directed to the image surface SB (which is formed by refraction characteristics of the medium surface or height error, with E being the horizontal distance between the medium surface S and the image surface SB) and light rays L3 are reflected therefrom. The light rays L3 reflect the images on the image surface SB to the spectroscope 33 (with the angle A1 between the light rays L3 and the medium surface S also being 89.00 degrees). After that, light rays L3 of the images are transmitted to the bi-focus aspheric toric lens 34 by the spectroscope 33 (light axis L3 is processed by aspheric toric surface). The optical sensor component 1 of wired or wireless optical mice or other optical input devices then captures images on image surface SB processed by the lens 34.

The spectroscopic lens module enables the optical sensors component of the wired or wireless optical mice or other optical input devices to capture images on certain medium surfaces such as glossy surfaces (glass, marble, metal, transparent plastic or photo paper) and multi-colored surfaces.

The optical input method of the present invention comprises the following steps: 1) Light rays are emitted from an infrared light source 2; 2) Light rays from the infrared light source 2 are refracted by a prism 32 to a refractive surface B2 of a spectroscope 33 such that the angle A2 between the refracted light rays L and the medium surface S is 1.00 degree; 3) Light rays refracted to the refractive surface B2 of the spectroscope 33 are refracted by the spectroscope 33 such that the angle A between the light rays refracted from the spectroscope and the medium surface S is 89.00 degrees; 4) Light axis of the refracted light rays having an angle of 89.00 degrees relative to the medium surface S is directed to reach the medium surface S or the image surface SB, and two-way image light axis L2, L3 of images on the medium surface S or the image surface SB are reflected to the spectroscope 33 respectively; 5) The two-way image light rays are transmitted to the bi-focus aspheric toric lens 34 respectively by the spectroscope 33. The optical sensor component 1 then captures images processed by the bi-focus aspheric toric lens 34.

In the present invention, the angle A3 of the spectroscope 33 is 44 degrees (i.e. the angle between the spectroscope 33 and the medium surface S is 44 degrees). To ensure that the light rays L1 refracted by the spectroscope 33 strike the medium surface S in the direction where the angle A between the light rays and the medium surface S is 89.00 degrees, light rays must be projected onto the spectroscope with an incident angle of 1.00 degree according to the optical refraction theory. Therefore, it must be guaranteed that the angle A2 between the light rays refracted by the prism 32 and the medium surface S is 1.00 degree. To ensure that the light rays emitted through the prism 32 can be accurately directed to and overlap with the light axis of the spectroscope 33 and the lens 34, the refractive surface B1 of the spectroscope has to overlap with the intersecting point B1 of light axis L and L1.

In the present invention, to ensure that the angle A2 between the light rays refracted by the prism 32 and the medium surface S is 1.00 degree, the prism 32 is with an angle A4 of 44.50 degrees (i.e. the angle between the prism 32 and the medium surface S is 44.50 degrees). According to the optical refraction theory, the incident rays which are reflected by the prism 32 with an angle of 44.50 degrees are projected at an angle of 1.00 degree in relation to the horizontal plane. To ensure that the refracted rays can be accurately projected to the medium surface S, the refracted light rays have to overlap with the light axis of the spectroscope 33.

In the present invention, the bi-focus aspheric toric lens 34 may take three forms. First, the lens is divided into a central toric lens and an outer toric lens. The focus of central toric lens is used for capturing images on medium surface S, while the focus of outer toric lens is used for capturing images on image surface SB. Second, the toric lens is divided into left and right halves. The focus of a half is used for capturing images on medium surface S, while the focus of another half is used for capturing images on image surface SB. Third, bi-focus lens with diffractive surface is used, so that the central part of one facet of the toric lens is equipped with diffractive surface. The focus of the lens with diffractive surface is used for capturing images on medium surface S, while the focus of another facet of the toric lens is used for capturing images on image surface SB.

In the present invention, the spectroscopic lens module simultaneously captures the two-way images by the following means: Light rays are refracted by the spectroscope 33 such that the angle A between the light rays and the medium surface S is 89.00 degrees; Light rays refracted by the spectroscope having an angle of 89.00 degrees relative to the medium surface S is directed to reach the medium surface S or the image surface SB respectively (which is formed by refraction characteristics of the medium surface or height error), and two-way image light axis L2, L3 of images on the medium surface S or the image surface SB are reflected to the spectroscope 33 respectively; The two-way image light rays L2, L3 are transmitted to P1, P2 of the bi-focus aspheric toric lens 34 respectively by the spectroscope. The optical sensor component 1 then captures images processed by the bi-focus aspheric toric lens 34.

What is claimed is:

1. An optical input device comprising a casing, an optical sensor component and an infrared light source; the optical sensor component and the infrared light source are disposed inside the casing, wherein it further comprises a spectroscopic lens module disposed inside the casing; the spectroscopic lens module comprises a prism which refracts incident rays such that the angle between the refracted light rays and the medium surface is 1.00 degree, a spectroscope which refracts incident rays such that the angle between the refracted light rays and the medium surface is 89.00 degrees, and a high-precision bi-focus aspheric toric lens; the prism is disposed on one side of light source where light rays are emitted; the spectroscope is disposed on one side of the prism where light rays are emitted; the lens is disposed on one side of the spectroscope where light rays are emitted.

2. The optical input device according to claim 1, wherein the spectroscopic lens module further comprises a base; the base, the prism, the spectroscope and the lens are assembled together as a whole.

3. The optical input device according to claim 1, wherein the prism, the lens and the spectroscope are embedded in corresponding receptacles of the base respectively.

4. The optical input device according to claim 1, wherein the angle between the spectroscope and the medium surface is 44 degrees; the angle between the prism and the medium surface is 44.5 degrees.

5. A spectroscopic lens module of an optical input device, wherein it comprises a spectroscopic lens module disposed inside a casing; the spectroscopic lens module comprises a prism which refracts incident light rays at an angle of 1.00 degree relative a medium surface, a spectroscope which refracts incident light rays at an angle of 89.00 degrees relative to the medium surface, and a bi-focus aspheric toric lens; the prism is disposed on one side of the light source where light rays are emitted; the spectroscope is disposed on one side of the prism where light rays are emitted; the lens is disposed on one side of the spectroscope where light rays are emitted.

6. The spectroscopic lens module of an optical input device according to claim 5, wherein the prism, the spectroscope and the lens are embedded in a base.

7. The spectroscopic lens module of an optical input device according to claim 5, wherein the toric surface of the lens is bi-focus aspheric toric surface.

8. The spectroscopic lens module of an optical input device according to claim 5, wherein the angle between the spectroscope and the medium surface is 44 degrees;
the angle between the prism and the medium surface is 44.5 degrees.

9. An optical input method, wherein it comprises the following steps:
1) Light rays are emitted from an infrared light source;
2) Light rays from the infrared light source are refracted by a prism to a refractive surface of a spectroscope such that the angle between the refracted light rays and the medium surface is 1.00 degree;
3) Light rays refracted to the refractive surface of a spectroscope are refracted by the spectroscope such that the angle between the light rays refracted from the spectroscope and the medium surface is 89.00 degrees;
4) Light axis of the refracted light rays having an angle of 89.00 degrees relative to the medium surface which are refracted from the spectroscope is directed to reach the medium surface, and light axis of images on the medium surface is reflected to the spectroscope;
5) Light rays of the images from the medium surface are transmitted to the bi-focus aspheric toric lens by the spectroscope; the optical sensor component then captures images processed by the bi-focus aspheric toric lens.

10. The optical input method according to claim 9, wherein the said step 4 further comprises the following: light axis of the refracted light rays is simultaneously directed to an image surface, the height of which is different from that of the medium surface; light axis of images on the image surface is then reflected to the spectroscope; and the said step 5 further comprises the following: light rays of the images from the image surface are simultaneously transmitted to the bi-focus aspheric toric lens.
